(19) United States
(12) Patent Application Publication
(10) Pub. No.: US 2015/0135596 A1
(43) Pub. Date: May 21, 2015

(54) Smoke or Fire Barrier

(71) Applicant: Coopers Fire Limited, Hampshire (GB)

(72) Inventor: Andrew Paul Cooper, Hampshire (GB)

(21) Appl. No.: 14/400,361

(22) PCT Filed: May 14, 2013
(86) PCT No.: PCT/GB2013/000219

§ 371 Date: Nov. 11, 2014

(30) Foreign Application Priority Data
May 16, 2012 (GB) 1208653.4

(51) Int. Cl. E06B 5/16; E05D 15/22; E05D 15/16; E06B 3/50; E05D 13/00

(52) U.S. Cl. CPC E06B 5/16; E06B 3/5063; E05D 13/1223; E05D 13/1253; E05D 15/165; E05D 15/22
USPC 49/420; 49/449; 49/423

(57) ABSTRACT

Fire and smoke barriers are deployed automatically on detection of fire of smoke. This can result in evacuees being on the wrong side of a deployed barrier and needing to evacuate through the barrier. The barrier includes a curtain rolled on a roller in a head box, a pair of side guides and a bottom bar. At least one of the side guides being partially movable, temporarily opening the barrier to allow the escape of an evacuee. Both side guides can be movable, allowing the barrier to swing from its top. Alternatively one side guide can be hinged to a wall with the other being able to move away from its wall, the head box joining the tops of the side guides. The barrier opens like a door to allow escape of an evacuee. The door having a closure spring to ensure it returns to its closed position.

The present invention relates to a smoke or fire barrier for inhibiting the travel of smoke and fire around a building.

Fire and smoke curtains are generally deployed automatically, as on detection of fire or smoke. This can result in evacuees being on the wrong side of a deployed barrier and needing to evacuate through the barrier.

Fire doors are provided in many situations where it is deemed necessary in order to avoid the spread of a fire in a building not equipped with automatically deploying smoke of fire barriers. Whilst such doors can be held open by latches automatically releasing in the event of fire, many fire doors are installed in positions where it is necessary for them to be normally closed. It is known for fire doors to be Is propped open, which not only renders them useless, thereby compromising the fire protection of the building putting occupants and property at risk, but can also render the building occupants liable to prosecution.

Typically fire curtains are to remain out of sight until required to deploy in the event of a fire. On deployment, the barrier may block an escape route. It is known to provide an override mechanism using mains or emergency power to temporarily retract the curtain.

However, as evacuees will be under extreme duress if trying to escape a fire, such override mechanisms may be overlooked.

We have developed a smoke or fire barrier able to be installed in a pedestrian way of the order of size of a passageway or doorway as opposed to larger barriers intended to divide up open areas of buildings such as departments of department stores. Our barrier provides an easily seen method for opening the barrier.

The object of the present invention is to provide an improved smoke or fire barrier.

According to the invention there is provided a smoke or fire barrier for a pedestrian way, having two sides and a head, the barrier comprising:

a curtain support normally arranged at the head of the pedestrian way;

a curtain normally supported by the curtain support for deployment down between the sides of the pedestrian way in event of smoke or fire; and

at least one movable side guide for the curtain, the guide normally extending at its side of the pedestrian way and being at least partially movable away from the side for at least partial, temporary opening of the barrier to allow escape of an evacuee needing to use the pedestrian way after deployment of the barrier.

Usually the curtain support will be a roller, with the curtain rolled on the roller for deployment therefrom. Alternatively the support can be a container for supporting a concertina fire curtain, also having a deployment mechanism for controlled descent of the curtain in the event of smoke or fire.

It can be envisaged that the movable side guide could extend only part way up its side, from floor level, allowing wheel chair or at least crawling egress through the deployed barrier, with a fixed guide extending up the side above the movable guide and the movable guide being pivotally attached to the side at the junction of the fixed and movable guides. However, normally the movable side guide will extend for the full height of its side. It can be pivotally attached to the top of the side, allowing the barrier to open partially as a triangular half of the barrier.

In one alternative, two pivotally attached side guides can be provided one at each side and both attached to the top of their sides. In this alternative, the barrier is able to open as the whole curtain swinging from the top. This is still likely to involve tall evacuees to have to duck for egress through the deployed barrier. Alternatively both side guides could be movable in their lower sections only, the lower part of the barrier swinging open. This will allow crawling egress for evacuees.

In another alternative, two movable side guides are provided, one being hinged to its side of the pedestrian way and the other being able to move away from its side throughout its height. In this alternative, a top member uniting the side guides is provided, with the barrier opening temporarily in the manner of a hinged door. Normally the curtain support will be carried with the top member, in a head box. The head box can perform the uniting function of the top member. Again, another alternative is for the side guides, top member and curtain support to be slideable sideways in the manner of a sliding door.

The top member can be attached to the hinged side guide with sufficient stiffness that the entire barrier is carried on the hinged side guide. Again, it can be envisaged that the bottom of the side guide moving away from its side can be supported by a roller or other supporting device.

Normally the curtain will have a bottom bar passing down the side guides as the curtain is deployed and interconnecting the bottoms of the side guides when the curtain is fully deployed. It can act to space the side guides apart, in particular avoiding one or other being pulled from the curtain when the barrier is temporarily opened.

Again, normally a release mechanism will be provided for normally holding the movable side guide—and other side guide and top member as appropriate—securely in fire/smoke retaining position against the side(s) and head of the pedestrian way respectively. For escape use, the release mechanism is typically operated with a handle to release the side guide. Importantly, the release mechanism will have a self closing latch. Normally the barrier will be arranged to open towards an escape route from a fire prone area, whereby in event of a fire in the fire prone area, fire draught will tend to close the barrier. Nevertheless a closure spring or other closure device will normally be provided for urging the movable side guide towards its closed position, ensuring closure after use.

The barrier can be configured and arranged for face fix or for reveal fix. That is to say the barrier can be provided with means for fixing to the face of a wall having an opening through which the pedestrian way passes in the manner of a doorway; alternatively, it can be provided with means for fixing to the reveal of an opening through which the pedestrian way passes in the manner of a doorway or indeed to the walls and ceiling of a passage through which the pedestrian way passes in the manner of a passageway.

In either case, that is to say face fix or reveal fix the barrier can be provided with a frame or cavity closure to be fitted in an opening in the wall. It should be noted that the word “closure” in the term “cavity closure” does not refer to closure of the opening in the wall which the barrier will block on deployment, but rather to closure at the opening of the cavity between two skins of the wall at opposite faces of the wall.

To help understanding of the invention, specific embodiments thereof will now be described by way of example in which:

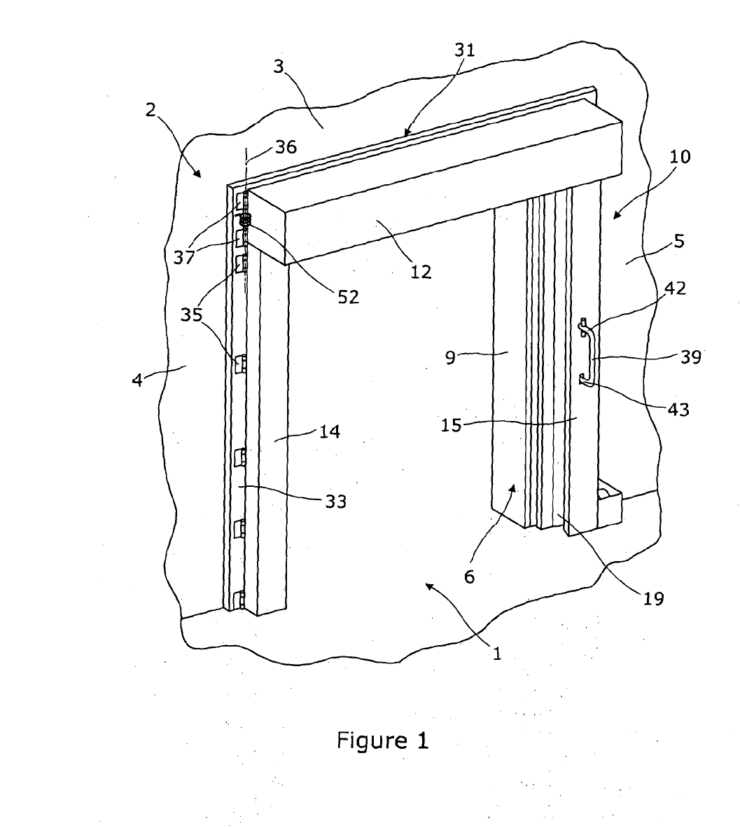

FIG. 1 is a perspective view of a first fire barrier in accordance with the invention, prior to deployment of the curtain;

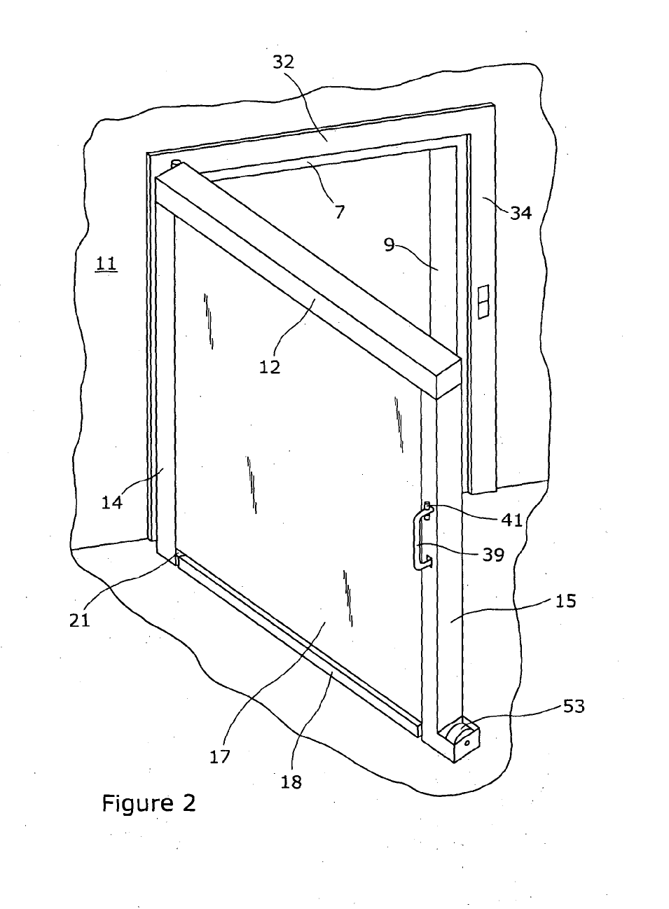

FIG. 2 is similar view of the barrier of FIG. 1, with the barrier deployed and temporarily opened;

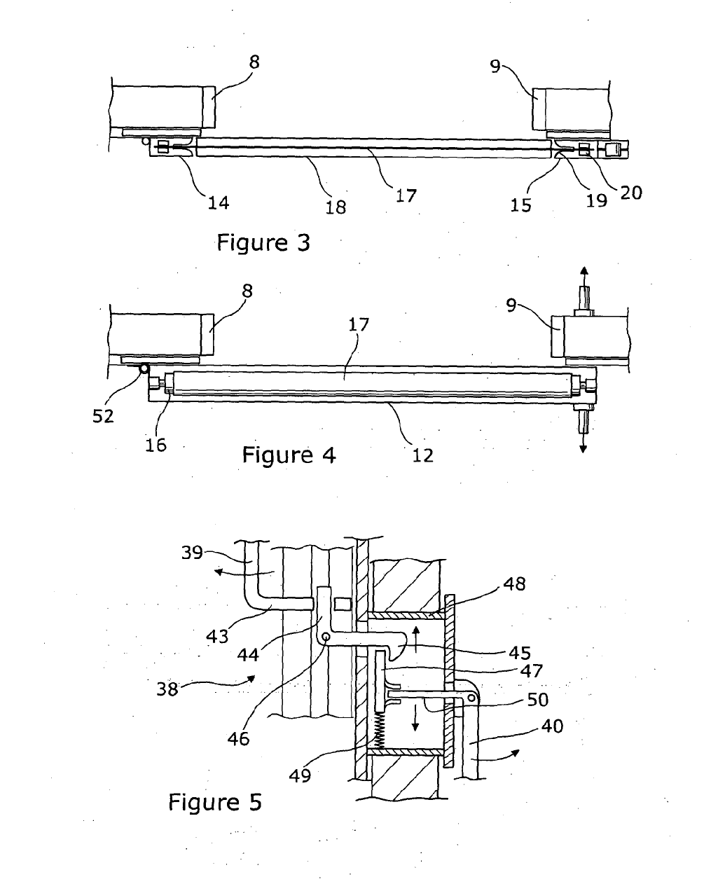

FIG. 3 is a cross-sectional plan view of the barrier of FIG. 1, deployed and closed, the section being just above the deployed bottom bar;

FIG. 4 is a similar cross-sectional view through the head box;

FIG. 5 is a scrap side view of a latch of the barrier;

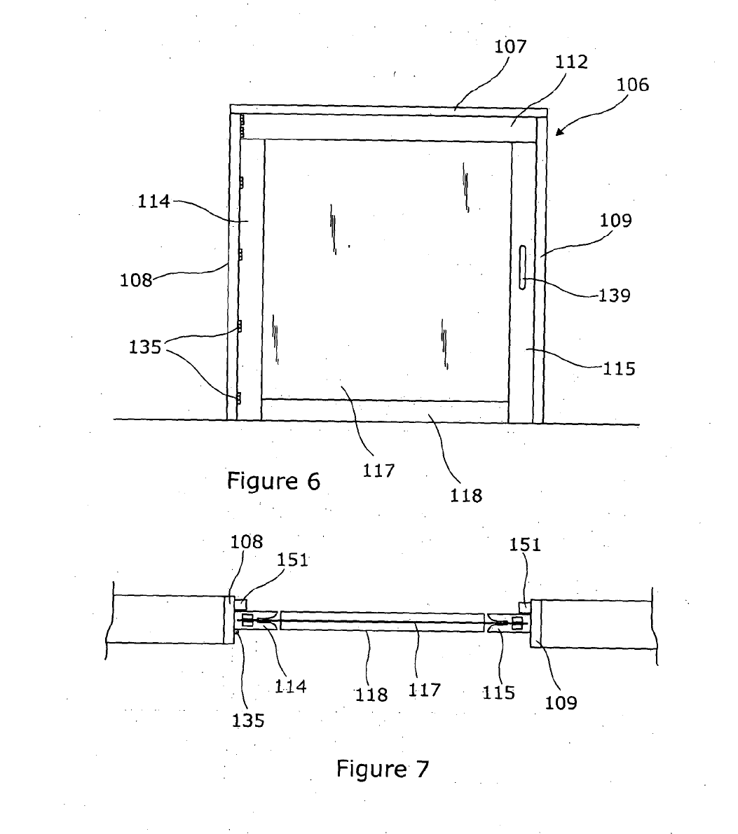

FIG. 6 is a front view of a second barrier of the invention;

FIG. 7 is a view similar to FIG. 3 of the barrier of FIG. 6;

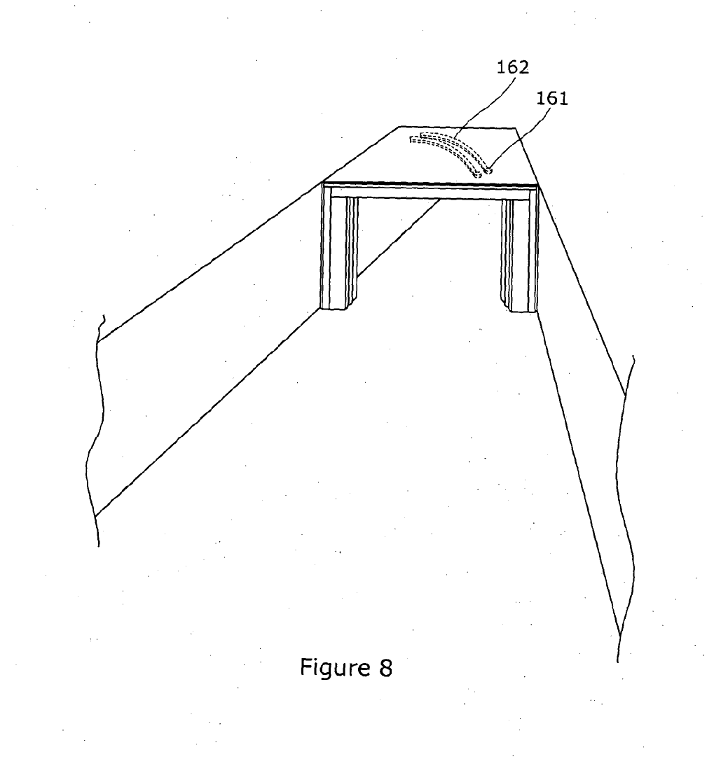

FIG. 8 is a perspective view of a variant of the barrier of FIG. 6;

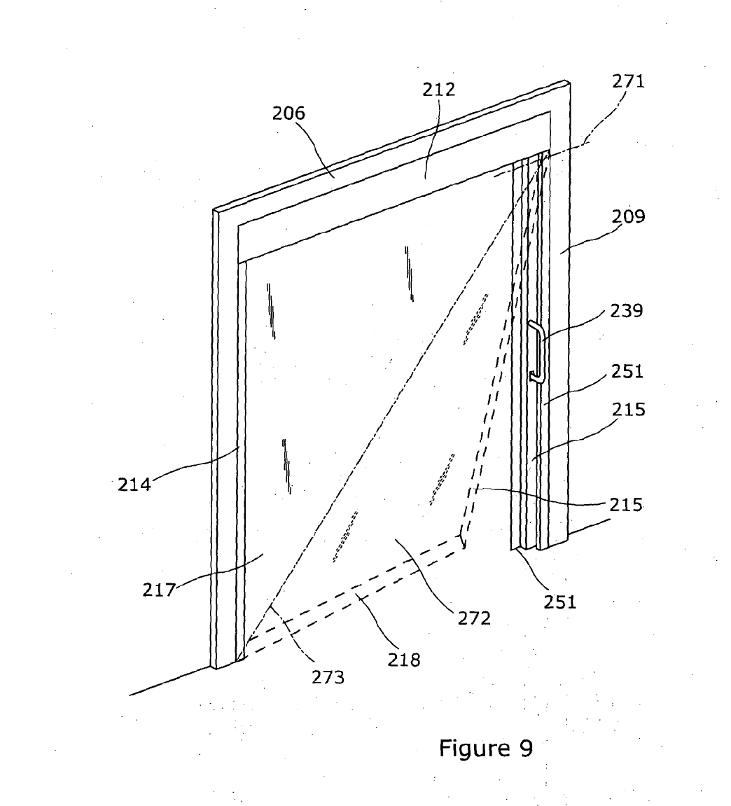

FIG. 9 is a view similar to FIG. 1 of a deployed and open third barrier of the invention;

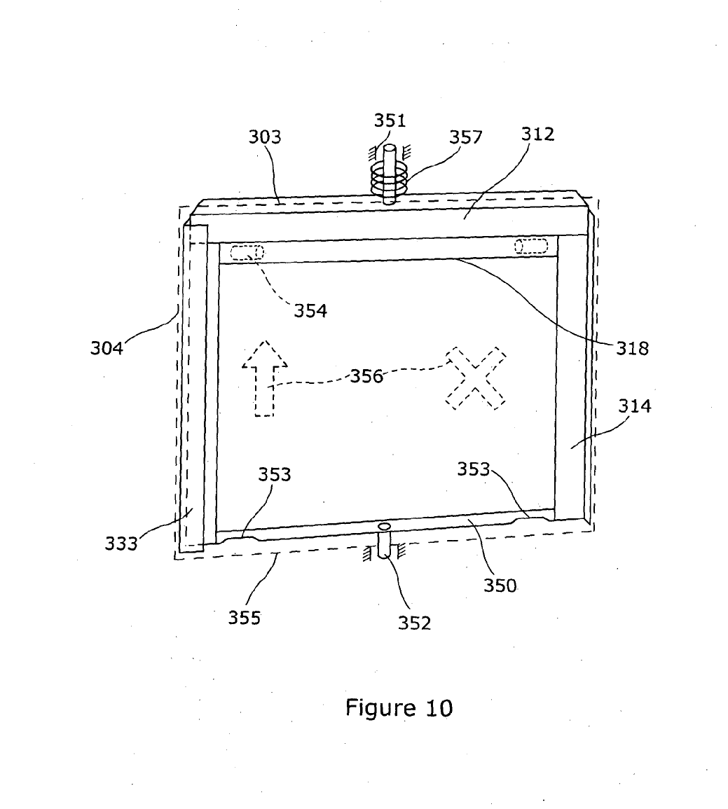

FIG. 10 is a perspective view of a further barrier according to the invention, prior to deployment;

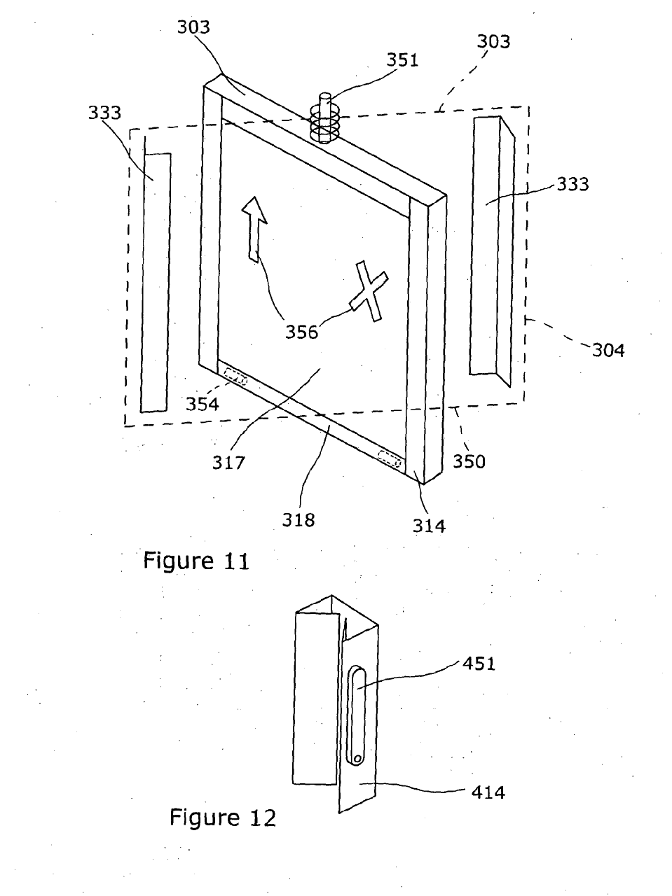

FIG. 11 is a similar view of the barrier of FIG. 10, with the barrier deployed and temporarily opened;

FIG. 12 is a scrap detail of a side guide of the barrier;

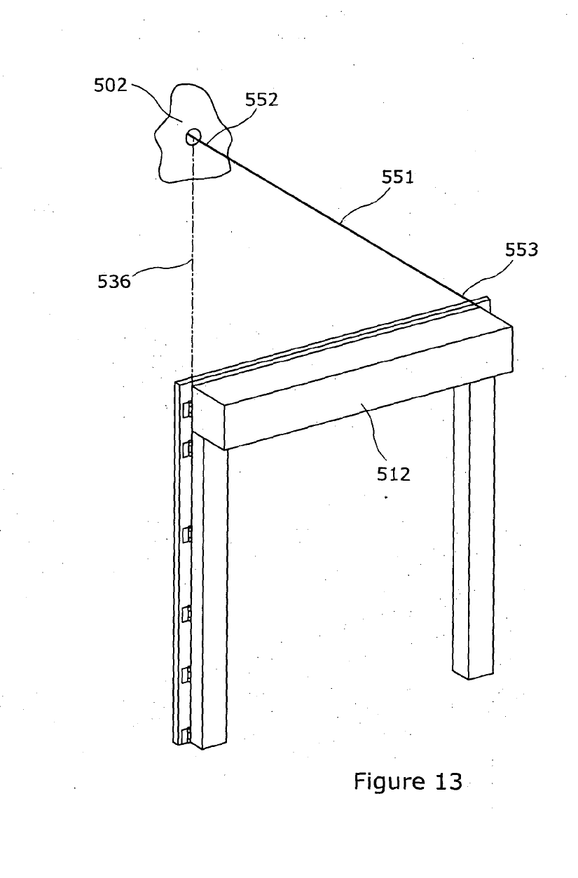

FIG. 13 is a perspective view of a further variant of the barrier of FIG. 1; and

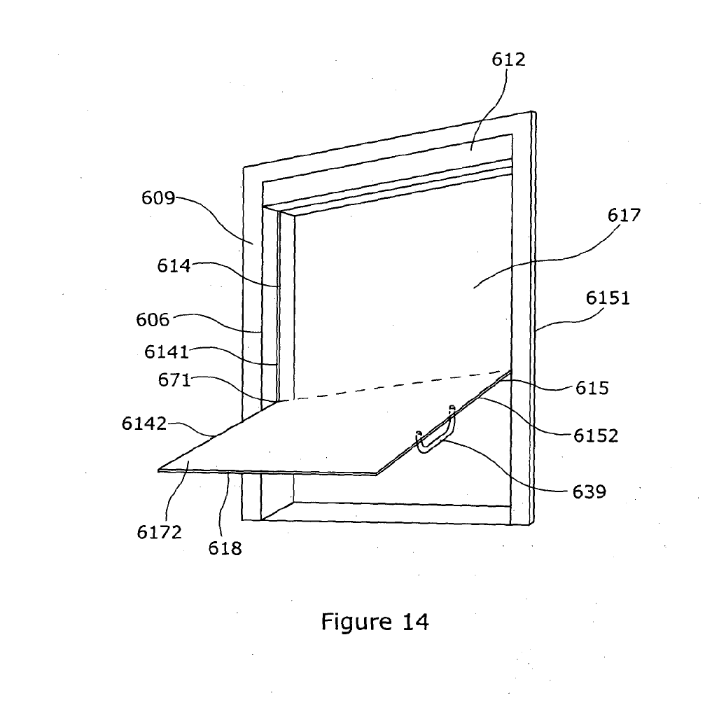

FIG. 14 is a perspective view of a further barrier according to the invention, deployed and temporarily opened.

Referring first to FIGS. 1 to 5, a doorway 1 in a wall 2 has a head 3 and two sides 4,5. In the doorway a lining frame 6 is installed and has a header 7 and two jambs 8,9. Instead of a conventional fire door hung in the frame on one of the jambs, a deployable fire barrier 10 in accordance with the invention is arranged on one face 11 of the wall, that is to say on the surface of one of the skins of the wall.

The fire barrier has a head box 12 and side guides 14,15. The head box accommodates a roller 16 with a fire resistant curtain 17 rolled on it. The roller is of a known type, having a combined internal motor, gearbox and brake (not shown) arranged for gravity failsafe deployment of the curtain in event of fire under the weight of a bottom bar 18. However other forms of roller or curtain deployment systems can be used. The side guides have in-turned lips 19 and the side edges of the curtain have buttons 20 held within the lips so that when the curtain is fully deployed, the bottom bar having reached the floor, the curtain can still resist a fire-draught pressure differential across it, without pulling out of the side guides. The bottom bar also has tongues 21 extending within the lips and buttons (not shown) fast on the tongues, so that bottom bar is captive between the side guides. These tongues may be rigid to enable rotation. Thus, for instance, in the event of an obstruction at one side guide the bottom bar will not tip and pull out of the other side guide.

The head box and side guides are attached to the face of the wall via a face frame 31. This comprises a cross member 32 at the head and two upright side members 33,34. These are fast with the wall.

The side guide 14 is pivotally connected to the side member 33. Usually this will be via hinges 35 aligned to have an upright hinge axis 36, although other types of pivotal connection could be used. The head box also is hinged at its end to the cross member 32 via additional hinges 37 on the hinge axis. These hinges are spaced one above the other sufficiently to support the head box without droop if it is hinged away from the wall. The side guides are of folded steel sheet. As such the hinged side guide 14 is unlikely to provide significant support against head box droop, but the connection between the head box and the side guide is made capable, with conventional sheet metal work techniques, of connecting the side guide 14 and the head box 12 to hinge as one.

The other side guide 15 is similarly attached to the head box at that latter's other end and hangs down from the head box when this is hinged away from the wall. The side guide is provided with sufficient stiffness for movement in the manner of a door, with the curtain deployed and the bottom bar maintaining constant the separation of the bottom ends of the side guides. It is envisaged that for further stiffness the bottom bar could lock into position at the bottom of the unit using a simple latch mechanism or solenoid.

Such hinging, whilst in accordance with the invention, is unusual during the installed life of the barrier, as indeed is deployment of the curtain, except for testing and service.

Normally the side guide 15 is latched to its side member 34 with a self-closing latch 38 openable by handles 39,40. Handle 39 is U-shaped and pivotally connected by pin 41 through its top limb 42 to the side guide; its lower limb 43 passes into the side guide 15. It receives a finger 44 of a striker 45, which is pivoted about pin 46 held in the side guide. The striker engages a slide plate 47 arranged in a box 48 on the inside of the side member 34, actually within the wall. The slide plate is held up by a spring 49 and engaged with a spigot 50 of the second handle 40 pivoted to the other face of the wall. The handles 39, 40 may be held within “break glass” boxes to prevent accidental release.

Pulling of the handle 39 releases the striker 45 from the plate 47, whereby the side guide can be pulled away from the side member 34 and the deployed barrier opened from the face 11 side of the wall. Pulling of the handle 40 releases the plate from the striker, whereby pressure on the deployed curtain opens the barrier in the same direction as with the handle 39.

A spring 52 is provided in the head box acting in torsion with respect to the hinge axis to urge the head box to return towards the cross member 32 when the former is hinged away from the latter. It is very important that once opened the barrier returns to its closed position, so it can perform its task of halting or slowing the spread of a fire. When the striker is pushed against the slide plate it lifts and re-engages the latch 38. The latch can be in multi-point as used in patio doors, or other similar closing devices.

Alternatively, the barrier can be urged to return to its closed position, from an open position, using rising hinges, spring hinges or floor damper closure hinges.

In event of a fire, in the building having the wall, with the face 11 of the wall having been chosen as opposed to the opposite face for installation of the barrier as facing towards an escape route, an evacuee finding escape blocked by deployed the barrier can open it in the direction of planned escape by use of the handle 40. It is anticipated that fire draught towards the fire from which he/she is escaping will tend to close the barrier. Should there be no fire draught, the spring 52 will tend to close the barrier. If the escapee is approaching from the other direction, he pulls on the handle 39 to open the deployed barrier.

A roller or wheel 53 can be provided at the foot of the movable side guide, for supporting the weight of the side guide.

Turning now to FIGS. 6 & 7, another barrier of the invention is shown installed within the reveal of a door way. It is essentially similar to that of the previous embodiment, save that the lining frame is adapted to perform the functions of the face frame in support the barrier.

The lining frame 106 has a header 107, jambs 108,109 and stops 151. The barrier has a head box 112 and side guides 114,115, with the former being hinged to the jamb 108 via hinges 135 and the latter being latched to jamb 109, a handle 139 for the latch only being shown in FIG. 6. A roller is accommodated in the head box with a curtain 117 having a bottom bar 118 deployable from the roller. Use and operation of the barrier is essentially the same as that of FIGS. 1 to 5 and will not be separated described.

Turning on again to FIG. 8, a variant is shown in which the barrier support frame is installed up the walls of a passage and across the ceiling. As such the barrier is bigger than a normal door way. In other respects it is similar, save that the end of the head box away from the hinge is supported by rollers 161 in a curved track 162 fixed to the ceiling. This allows the headbox and thus the curtain from the roller open like a door as the side guides hinge away from the wall.

Another embodiment of a reveal fix barrier is shown in FIG. 9. This barrier has its head box 212 and one side guide 214 fixed to its lining frame 206. The other side guide 215 is pivotally attached to the lining frame jamb 209 at its top about a horizontal pivot axis 271. This side guide is free to swing away from the stop 251, when the barrier's latch and handle 239 is released. Thus a triangular half 272 of the curtain 217 including the side guide 215 and the bottom bar 218 are free to swing from the closed position of the curtain, the swing being beneath a diagonal axis 273 of the barrier. This embodiment is simpler than those involving a moving head box, provides easy escape for smaller people and stooping escape for taller people.

It should be noted that this embodiment does not have a closure spring, being closed by gravity in the manner of a pendulum.

Turning to FIGS. 10 & 11, a further embodiment is shown, in which a head box 312 is pivoted centrally in a passageway, with a support bearing 351 carrying the weight of the head box let into the ceiling 303. At the side walls 304 of the passage, a pair of essentially L section jambs 333 are arranged, providing fire control vis-à-vis side guides 314 depending from the head box 312. A flat threshold member 350 extends across between the side guides. It also has a central bearing 352 in the floor 355. In the event of a fire, a curtain 317 deploys from the head box, guided by side guides, with a bottom bar 318, coming to rest on the threshold member. This has narrower portions 353 at its ends corresponding to positions in the bottom bar of rollers 354, which are journalled in the bottom bar aligned with the bar and rest on the floor 355, when the bar is deployed. Thus they carry its weight. The curtain is marked 356 so that evacuees know to push on the left side of the curtain, to cause the deployed barrier to swing about its central axis defined by the bearings 351,352. In opening the side guides move away from their L-jambs. A return spring 357 is provided at the upper bearing 351, so that once evacuees have passed the barrier returns to its effective position.

FIG. 12 shows in scrap detail a pair of fingers 451 pivoted to the side guides 414 at their bottom ends. On release and descent of the bottom bar, the fingers are released to swing down and lay on top of the bottom bar. In this way, they stabilise the connection of the deployed bottom bar and the lower ends of the side guides.

FIG. 13 shows diagrammatically a support wire 551 for a variant of the embodiment of FIG. 1. At an upper end 552 the support wire is attached to the wall 502 having an opening at which a barrier of the invention is arranged. The point of attachment is on the hinge axis 536 to the left of the barrier, about which it opens. The lower end 553 of the wire extends diagonally down and is fastened to the other end of the head box 512, for supporting its weight.

Now turning to FIG. 14, the embodiment there shown is openable at its lower end only. This reveal fix barrier has its head box 612 fixed to its lining frame 606. Upper portions 6141, 6151 of sides guides 614, 615 are attached to the lining frame jamb 609. Lower portions 6142, 6152 of the side guides are pivotally attached to the upper portions about horizontal pivot points 671. The lower portions of the sides guides are free to swing away from the upper portions when the barrier's latch and handle 639 is released. The tower portion 6172 of the curtain 617 is free to swing away from its closed position, providing an opening through which evacuees can pass, generally by crawling. The bottom bar 618 providing rigidity along the bottom of the curtain. The pivot points between the upper 6141, 6151 and lower 6142, 6152 portions of the side guides 614, 615 could be at any height. As shown they are at approximately half the height of the barrier. This provides sufficient height of movable barrier for an evacuee to crawl or duck under, but maintains a smoke and fire barrier at the upper portions. As smoke travels across ceilings, this provides an important barrier to the spread of fire in a building. Once an evacuee has passed through the barrier, the barrier closes under gravity, restoring the integrity of the barrier.

In other non-illustrated variants:

1. Both side guides are top pivoted to provide the simplicity of the previous embodiment together with full barrier width escape;

2. The head box is able to hinge, possibly being ceiling supported at a curved track, and the moving side guide is able to pivot. In this variant, a single escapee can push through the triangular swing portion of the curtain, with reasonable certainty of the barrier closing again in a fire tight manner due to its pendulum support. If several escapees are pushing through the barrier, its full width can open, albeit with less certainty of fire tight re-closure.

3. The side guides and top member, including the curtain support, are slideable sideways in the manner of a sliding door.

1. A smoke or fire barrier for a pedestrian way, having two sides and a head, the barrier comprising:
a curtain support normally arranged at the head of the pedestrian way;
a curtain normally supported by the curtain support for deployment down between the sides of the pedestrian way in event of smoke or fire; and
at least one movable side guide for the curtain, the guide normally extending at its side of the pedestrian way and being at least partially movable away from the side for at least partial, temporary opening of the barrier to allow escape of an evacuee needing to use the pedestrian way after deployment of the barrier.

2. A smoke or fire barrier according to claim 1, wherein a portion of the at least one movable side guide is movable, the movable portion extending part way up the side guide from floor level and a fixed guide extending up above the movable guide, the movable guide being pivotally attached to the side at the junction of the fixed and movable guides, allowing part of the barrier to partially open at the movable portion of the side guide.

3. A smoke or fire barrier according to claim 1, wherein the movable side guide extends the full height of its side.

4. A smoke or fire barrier according to claim 3, wherein the movable side guide is pivotally attached to a top of the side, allowing the barrier to open partially as a triangular half of the barrier.

5. A smoke or fire barrier according to claim 1, wherein two movable side guides are provided.

6. A smoke or fire barrier according to claim 5, wherein each of the movable side guides are pivotally attached to a top of their sides, allowing the whole curtain to swing from the top for allowing egress of evacuees along the pedestrian way.

7. A smoke or fire barrier according to claim 5, wherein one of the movable side guides is hinged to its side of the pedestrian way and the other movable side guide is able move away from its side throughout its height.

8. A smoke or fire barrier according to claim 7, further including a top member uniting the side guides, with the barrier opening temporarily in the manner of a hinged door.

9. A smoke or fire barrier according to claim 8, wherein the curtain support is carried with the top member, in a head box.

10. A smoke or fire barrier according to claim 8, wherein the bottom of the side guide which moves away from its side is supported on a roller.

11. A smoke or fire barrier according to claim 5, wherein the two movable side guides are able to move away from their sides and are connected by a top member uniting the guides and containing the curtain support, the side guides and the top member and curtain support being slideable sideways in the manner of a sliding door.

12. A smoke or fire barrier according to claim 1, wherein the curtain is provided with a bottom bar passing down the side guides as the curtain is deployed and interconnecting the bottoms of the side guides when the curtain is fully deployed.

13. A smoke or fire barrier according to claim 1, further including a release mechanism for normally holding the movable side guide securely in a fire/smoke retaining position against the side of the pedestrian way.

14. A smoke or fire barrier according to claim 13, wherein the release mechanism includes has a self closing latch.

15. A smoke or fire barrier according to claim 1, wherein the barrier is arranged to open towards an escape route from a fire prone area, whereby in event of a fire in the fire prone area, fire draught will tend to close the barrier.

16. A smoke or fire barrier according to claim 1, further including a closure spring for urging the movable side guide towards its closed position.

17. A smoke or fire barrier according to claim 1, wherein the barrier is provided with means for fixing to the face of a wall having an opening through which the pedestrian way passes in the manner of a doorway.

18. A smoke or fire barrier according to claim 1, wherein the barrier is provided with means for fixing to the reveal of an opening through which the pedestrian way passes in the manner of a doorway or to the walls and ceiling of a passage through which the pedestrian way passes in the manner of a passageway.

19. A smoke or fire barrier according to claim 1, wherein the curtain support is a roller on which the curtain is normally rolled for deployment.

20. A smoke or fire barrier according to claim 9, wherein the bottom of the side guide which moves away from its side is supported on a roller.
